(19) United States
(12) Patent Application Publication
(10) Pub. No.: US 2014/0292062 A1
(43) Pub. Date: Oct. 2, 2014

(54) Automotive Rims

(71) Applicants: Ruben Luzanilla, Los Angeles, CA (US); Antonio Munoz, Phoenix, AZ (US)

(72) Inventors: Ruben Luzanilla, Los Angeles, CA (US); Antonio Munoz, Phoenix, AZ (US)

(21) Appl. No.: 13/851,051

(22) Filed: Mar. 26, 2013

(51) Int. Cl. B60B 3/00

(52) U.S. Cl. CPC B60B 3/002
USPC 301/64.101; 29/894.35

(57) ABSTRACT

Generally described are specially designed tire or wheel-rims that are adorned with the logos of professional and college athletic teams. In one embodiment, rims according to the present disclosure provide automobile enthusiasts and sport aficionados a unique means of celebrating a favorite sports team, while adding a dazzling personal touch to ordinary tires and rims. The features of the preferred embodiments which are believed to be novel are particularly pointed out and distinctly claimed in the concluding portion of the specification.

### CROSS-REFERENCE TO RELATED APPLICATIONS

This document claims the benefit and priority of U.S. Provisional Patent Application Ser. No. 61/615,893 that was filed on Mar. 27, 2012 and entitled “Chromz.” Said provisional application is hereby incorporated by reference in its entirety.

### STATEMENT RE: FEDERALLY SPONSORED RESEARCH OR DEVELOPMENT

Not Applicable.

### BACKGROUND

1. Field of the Invention

The present invention relates generally to the field of specialty rims and more specifically relates to specialty automotive rims.

2. Description of Related Art

Frequently, automobile owners customize their automobiles. For instance, some owners use automobile accessories like personalized license plates, floating neon lights or fancy mud flaps to personalize their vehicles or set the same apart from stock vehicles. Other vehicle owners customize their machines as a form of expression. Not surprisingly, accentuating one's vehicle via a customized paint job, monogrammed upholstery, or other personalized elements provides auto enthusiasts an exciting and artistic way in which to express themselves.

One way by which people revamp the overall appearance of their automobiles (e.g., cars, trucks, vans or motorcycles), is by installing a new set of tires and wheel rims. That is to say, a new set of tires or rims can vastly improve the appearance of any automobile. However, tires and rims are difficult to personalize because their utility frequently dictates their form. As a result, tires and rims are typically only made in a limited variety of styles, such as mag wheels, low profile, whitewashed and modular. Accordingly, a need exists for rims or tires that are more readily personalizable than heretofore known rims or tires.

Various attempts have been made to satisfy the need found in wheel rims art. Among these are specialty rims with personalized indicia disclosed in U.S. Pub. No. 2005/0206219 to Peter J. Johnson and U.S. Pat. No. 5,464,276 to Roderick L Ott.; and U.S. Pat. No. 5,316,376 to Manuel P. While such disclosures provide personalized content to automobile rims, the same do not adequately provide a means for personalization of rim form and content. Accordingly a need exists for improved rims or tires that with readily personalizable form and content.

### BRIEF SUMMARY OF THE INVENTION

In view of the foregoing needs inherent to known wheel-rims, the present disclosure describes novel rims that satisfy said needs. Generally described are specially designed tire or wheel-rims that are adorned with the logos of professional and college athletic teams. In one embodiment, rims according to the present disclosure provide automobile enthusiasts and sport aficionados a unique means of celebrating a favorite sports team, while adding a dazzling personal touch to ordinary tires and rims. The features of the preferred embodiments which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The FIGURE which accompanies the written portion of this specification illustrate embodiments and method(s) of use for the present invention, Chromz, constructed and operative according to the teachings of the present invention.

FIG. 1 shows a perspective view illustrating different possible embodiments of a preferred embodiment of the disclosed rims.

The various embodiments of the present invention will herenafter be described in conjunction with the appended drawings. It should be noted that the FIGURE is not necessarily to scale.

### DETAILED DESCRIPTION OF THE PREFERRED EMBODIMENT

As discussed above, embodiments of the present invention relate to a specialty rims device and more particularly to a specially designed set of tire rims that are adorned with the logos of professional and college athletic teams worldwide of all sports. Design intent is to provide automobile enthusiasts and sport aficionados a unique means of celebrating a favorite sports team, while adding a dazzling touch to ordinary tires, as used to improve the appearance of vehicles.

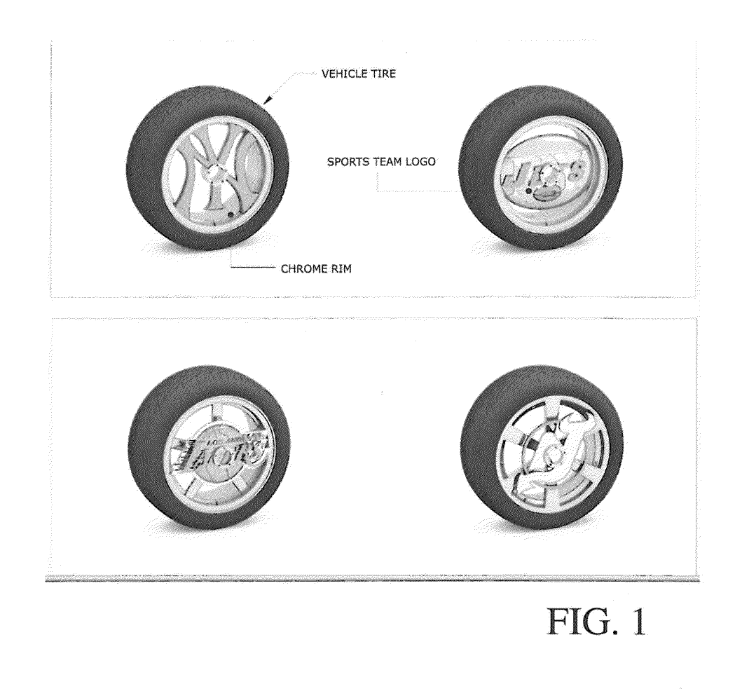

Referring now to the drawing FIG. 1, disclosed is a line of elegantly crafted tire rims, each adorned with the logo of a specific professional and college sports team worldwide of all sports. Manufactured of polished chrome material, the disclosed rims would be generally similar in structure to a standard set of tire rims. As such, these rims would be circular shaped discs designed to be installed over the existing tire mount, adding a striking decorative touch to the overall tire design. The disclosed rims are preferably configured for production in a variety of sizes, with 17″, 18″, 19″, 20″, 22″, 24″, 26″ and 28″ rims all included in the line. A notable feature of the disclosed rims may be the rendered logos themselves. Carefully etched into the rims, or raised on the rim's surface, the professional athletic or university logo could also be enameled or painted on the rims in bold and vibrant colors, creating a striking contrast to the polished chrome. In an alternate embodiment, the logo itself may define the spokes of the rim (see, e.g., the New York Yankee or Jets themed rims shown in FIG. 1).

The disclosed rim line may suitably feature the logos of all professional teams from all sporting genres, such as football, basketball, baseball, soccer, and hockey, as well as the logos of university teams or simple college insignias. For instance, the disclosed rims may be offered adorned with the logo of the New York Yankees baseball team, the Chicago Blackhawks hockey team, or the San Diego Chargers football team, to name a few options. It is important to note however, that when using logos and images to adorn the rims, licensing concerns must be addressed.

Use of the disclosed rim is simple and straight forward. First, the consumer would choose a set of rims according to his or her favorite athletic team. By way of example, a diehard New York Knicks basketball fan would purchase rims emblazoned with the Knicks logo, while a football enthusiast might choose rims adorned with the logo of the St. Louis Rams, USC Trojans, or any other favorite team. The consumer may then have the rims professionally installed on their vehicle by a mechanic or service technician, or in the case of the skilled auto lover, they would simply install the rims themselves.

There are many benefits and advantages associated with the disclosed rims. Foremost, the disclosed rims provide automobile enthusiasts, with a striking and attractive means of improving the appearance of their car. Dazzling and unique, the disclosed rims offer the car lover a unique means in which to transform the look of their ride. Additionally, the disclosed rim line offers the sport enthusiast an easy means of turning an ordinary set of tire rims into dazzling, celebratory showpieces. Boldly displaying the logo of any professional or collegiate team, the disclosed rims offer consumers a unique means of showing fan appreciation or pride in one's alma mater. Offering a classy and unique way in which to offer a “shout-out” to a beloved sports team, the disclosed rims would prove a striking conversation piece at any tailgating party or simply when parking one's vehicle at work or school. Auto lovers who collect vintage classics or who enjoy restoring newer oars, will especially appreciate these striking rim designs. Another advantage is that the disclosed rims may provide the car lover a creative means of customizing their automobile to express their very own tastes and to suit their individual personality. Fully functional, tires would run smoothly and efficiently on the disclosed rims.

A rim according to this disclosure is a cleverly designed product invention which would offer car enthusiasts a unique means of turning standard tires into attractive and fancy pieces of art that celebrate a favorite sports team. Easy to install, these unique, sports-themed rims would almost instantly transform the appearance of any vehicle.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing description is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

We claim:

1. A specially designed set of tire rims that are adorned with a logo.

2. The set of tire rims of claim 1 wherein the logo is of a professional sports team.

3. The set of tire rims of claim 1 wherein the logo is of a college athletic team.

4. The set of tire rims of claim 1 wherein the logo is etched into the surface of the spokes structures of the rims.

5. The set of tire rims of claim 1 wherein the logo is raised above the surface of the spokes structures of the rims.

6. The set of tire rims of claim 1 wherein the logo defines the support spokes of the rim.

7. A method of using a set of rims comprising:
obtaining a set of rims that are adorned with a logo; and,
installing the set of rims on a vehicle.

8. The method of claim 7 wherein the logo is of a professional sports team.

9. The method of claim 7 wherein the logo is of a college athletic team.

10. The method of claim 7 wherein the logo is etched into the surface of the spokes structures of the rims.

11. The method of claim 7 wherein the logo is raised above the surface of the spokes structures of the rims.

12. The method of claim 7 wherein the logo defines the support spokes of the rim.

13. A method of celebrating a sports team and driving a car comprising the steps of:
obtaining a logo for a sports team;
fixedly connecting said logo to a rim of an automobile wheel;
operating a vehicle to which the automobile wheel is secured; and,
displaying the logo wherein passersby see the logo.

14. The method of claim 13 wherein the logo is etched into the surface of the spokes structures of the rims.

15. The method of claim 13 wherein the logo is raised above the surface of the spokes structures of the rims.

16. The method of claim 13 wherein the logo defines the support spokes of the rim

17. The method of claim 13 wherein the wheel turns during the step of operating the vehicle.

18. The method of claim 13 wherein the logo turns with the car wheel.

19. The method of claim 16 wherein the wheel turns during the step of operating the vehicle.

20. The method of claim 19 wherein the logo turns with the car wheel.
